(19) United States
(12) Patent Application Publication
(10) Pub. No.: US 2009/0277519 A1
(43) Pub. Date: Nov. 12, 2009

(54) METHOD AND APPARATUS FOR CONTROLLING FLUID FLOW RATE CHARACTERISTICS OF A VALVE ASSEMBLY

(75) Inventors: Lawrence Edward Parker, Castaic, CA (US); Delton Boardman, Acton, CA (US); Robert Deller, Valencia, CA (US)

Correspondence Address: Bainwood, Huang & Associates, LLC, 2 Connector Road, Westborough, MA, 01581, US

(73) Assignee: HR TEXTRON, INC., Santa Clarita, CA (US)

(21) Appl. No.: 12/115,996

(22) Filed: May 6, 2008

(51) Int. Cl. F16K 31/06; F16K 31/02; G06F 9/44

(52) U.S. Cl. 137/625.65; 251/129.11; 717/106

(57) ABSTRACT

A valve assembly controller is configured with a table having a set of command signal values representing commanded positions of a valve element to obtain a desired flow rates through a fluid pathway. The table also includes a set of empirically measured drive signal values representing the actual positions of the valve element required to obtain the desired flow rates through the fluid pathway. During operation, in order to obtain a desired flow rate through the fluid pathway, the controller intercepts a command signal from a command signal source and provides the valve assembly with a corresponding drive signal based upon the table values. The controller therefore controls the positioning of the valve element such that the valve element is opened to a position either greater or less than the commanded position in order to provide the desired flow through the fluid pathway.

### BACKGROUND

Electronically controlled valve assemblies are utilized in the aerospace industry to control the flow and delivery of fluid through various aircraft systems. For example, conventional direct drive servovalves are utilized as part of aircraft systems to convert relatively low power electrical control input signals into a relatively large mechanical power output. A typical direct drive servovalve includes a housing, a valve member such as a spool, a motor, and a sensor. The housing defines a fluid pathway with the valve member being disposed within the fluid pathway. The motor is configured to move the valve member within the fluid pathway between an open and closed position in order to control an amount of fluid flow within the pathway. The sensor is configured to sense a position of the valve member within the fluid pathway and a rotational orientation of the motor's rotor assembly.

During operation, an electronic controller receives a command signal from a user input device which directs the controller to operate the servovalve in a particular manner (e.g., increase flow, decrease flow, terminate flow, etc.). The controller also receives a position signal from the sensor thus enabling the controller to determine the present position of the valve member within the fluid pathway. The controller then sends a control signal to the motor based on both the command signal and the position signal to control the rotational orientation of the rotor assembly. As a result, the rotor assembly moves the valve member to a desired position within the fluid pathway to control an amount of fluid that flows through the servovalve thereby driving a fluid actuator to operate variable-geometry elements such as associated with an aircraft.

Additionally, butterfly or poppet valves are utilized as part of aircraft fuel systems to control an amount of fuel delivered to an aircraft's various systems. Conventional butterfly valves control fluid flow rates within a flow channel via an adjustment of a position of a valve plate, or throttle plate, within the flow channel. For example, in response to a command signal, a motor is configured to rotate the valve plate between an open position, where a face of the valve plate orients parallel to a flow within a fluid pathway, and a closed position, where a face of the valve plate orients perpendicular to the flow within the fluid pathway, decreases the fluid flow rate within the channel. Such rotation adjusts an amount of fuel provided to an aircraft's various systems.

### SUMMARY

Conventional valve assemblies suffer from a variety of deficiencies. Typically, while a command signal is used to adjust the positioning of the valve element within the fluid pathway, the valve elements generally create non-linear rate of flow change characteristics. Taking poppet valves as an example, assume a controller sends a control signal to a motor to position the poppet valve's valve plate to a 50% open position. In response to the control signal, because of the non-linear rate of flow change characteristics, the valve plate can be positioned within the fluid pathway to allow either a larger or smaller volume of fluid through the pathway than desired. Such positioning leads to an inaccurate volume flow rate through the fluid pathway when compared to the commanded position. Additionally, with conventional valve assemblies, the velocity of the valve element is typically controlled through a single variable parameter, resulting in the valve element moving with a substantially constant velocity during a valve stroke. Accordingly, in the case of the poppet valve, if the poppet valve element is allowed to rapidly change position relative to the valve seat when it is close to the seat, a pressure surge can occur either downstream, when opening, or upstream, when closing, relative to the valve element. This pressure surge, termed water hammer, can cause damage to the valve or other system components.

By contrast to conventional valve assemblies, embodiments of the present invention relate to a method and apparatus for controlling fluid flow rate characteristics of a valve assembly. A controller is configured with a table having a set of command signal values representing commanded positions of a valve element to obtain a desired flow rates through a fluid pathway. The table also includes a set of empirically measured drive signal values representing the actual positions of the valve element required to obtain the desired flow rates through the fluid pathway. During operation, in order to obtain a desired flow rate through the fluid pathway, the controller intercepts a command signal from a command signal source. Because of non-linear rate of flow change characteristics, the command signal would position a valve of the valve assembly within the fluid pathway to allow either a larger or smaller volume of fluid through the pathway than desired. Accordingly, the controller provides the valve assembly with a corresponding drive signal based upon the table values. The controller therefore controls the positioning of the valve element such that the valve element is opened to a position either greater or less than the commanded position in order to provide the desired flow through the fluid pathway. Accordingly, in one embodiment the controller is configured to provide a linearization of flow characteristics through any liquid or gas media valve assembly.

In one arrangement, based upon the table, the controller is configured to adjust the opening and closing rate-of-change profiles to meet customer requirements for each specific valve configuration. Additionally, the controller is configured to control the rate of positional change of the valve element at certain points in the stroke of the valve element to reduce hydraulic water hammer and system pressure surges within the fluid pathway.

In one arrangement, a method for controlling a flow rate characteristic of a valve assembly includes receiving a command signal having a command signal value, the command signal configured to position a valve of the valve assembly between a first position and a commanded position to provide a flow of fluid through a fluid pathway according to a first flow rate characteristic. The method includes accessing a flow control table to detect a drive signal value corresponding to the command signal value, the flow control table relating a set of command signal values to a corresponding set of drive signal values, the set of drive signal values corresponding to a set of flow rate values of the valve assembly. The method includes providing a drive signal associated with the drive signal value to the valve assembly, the drive signal configured to position the valve of the valve assembly between a first position and a driven position to provide a flow of fluid through the fluid pathway according to a second flow rate characteristic, the second flow rate characteristic distinct from the first flow rate characteristic.

In one arrangement, a flow control system includes a valve assembly having a valve disposed within a fluid pathway and a motor operatively coupled to the valve and a controller in electrical communication with the motor. The controller is configured to receive a command signal having a command signal value, the command signal configured to cause the motor to position the valve of the valve assembly between a first position and a commanded position to provide a flow of fluid through the fluid pathway according to a first flow rate characteristic. The controller is configured to access a flow control table to detect a drive signal value corresponding to the command signal value, the flow control table relating a set of command signal values to a corresponding set of drive signal values, the set of drive signal values corresponding to a set of flow rate values of the valve assembly. The controller is configured to provide a drive signal associated with the drive signal value to the valve assembly, the drive signal configured to cause the motor to position the valve of the valve assembly between a first position and a driven position to provide a flow of fluid through the fluid pathway according to a second flow rate characteristic, the second flow rate characteristic distinct from the first flow rate characteristic.

In one arrangement, a computer program product having a computer-readable medium include computer program logic encoded thereon that, when performed on a controller of a computerized device configures the controller to receive a command signal having a command signal value, the command signal configured to cause the motor to position the valve of the valve assembly between a first position and a commanded position to provide a flow of fluid through a fluid pathway according to a first flow rate characteristic, access a flow control table to detect a drive signal value corresponding to the command signal value, the flow control table relating a set of command signal values to a corresponding set of drive signal values, the set of drive signal values and the set of command signal values corresponding to a set of flow rate values of the valve assembly, and provide a drive signal associated with the drive signal value to the valve assembly, the drive signal configured to cause the motor to position the valve of the valve assembly between a first position and a driven position to provide a flow of fluid through the fluid pathway according to a second flow rate characteristic, the second flow rate characteristic distinct from the first flow rate characteristic.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 illustrates a schematic representation of a flow control system, according to one embodiment.

FIG. 2 is a graph showing a relationship between valve assembly motor state counts and a flow rate through the valve assembly for a desired valve position and the relationship between valve assembly motor state counts and a flow rate through the valve assembly for a corrected valve position, according to one embodiment.

FIG. 3 illustrates a schematic representation of a controller of FIG. 1, the controller configured with a flow control table.

FIG. 4 is a flowchart of a method performed by the controller of FIG. 1 to control the flow of fluid through a fluid pathway, according to one embodiment.

FIG. 5 is a flowchart of a process performed by the controller of FIG. 1 to dampen the change of rotational velocity of the valve of the valve assembly during operation.

FIG. 6 illustrates signal profiles of an input signal after processing by the controller as shown in FIG. 5.

### DETAILED DESCRIPTION

Embodiments of the present invention relate to a method and apparatus for controlling fluid flow rate characteristics of a valve assembly. A controller is configured with a table having a set of command signal values representing commanded positions of a valve element to obtain a desired flow rates through a fluid pathway. The table also includes a set of empirically measured drive signal values representing the actual positions of the valve element required to obtain the desired flow rates through the fluid pathway. During operation, in order to obtain a desired flow rate through the fluid pathway, the controller intercepts a command signal from a command signal source. Because of non-linear rate of change characteristics, the command signal would position a valve of the valve assembly within the fluid pathway to allow either a larger or smaller volume of fluid through the pathway than desired. Accordingly, the controller provides the valve assembly with a corresponding drive signal based upon the table values. The controller therefore controls the positioning of the valve element such that the valve element is opened to a position either greater or less than the commanded position in order to provide the desired flow through the fluid pathway. Accordingly, in one embodiment the controller is configured to provide a linearization of flow characteristics through any liquid or gas media valve assembly.

In one arrangement, based upon the table, the controller is configured to adjust the opening and closing rate-of-change profiles to meet customer requirements for each specific valve configuration. Additionally, the controller is configured to control the rate of positional change of the valve element at certain points in the stroke of the valve element to reduce hydraulic water hammer and system pressure surges within the fluid pathway.

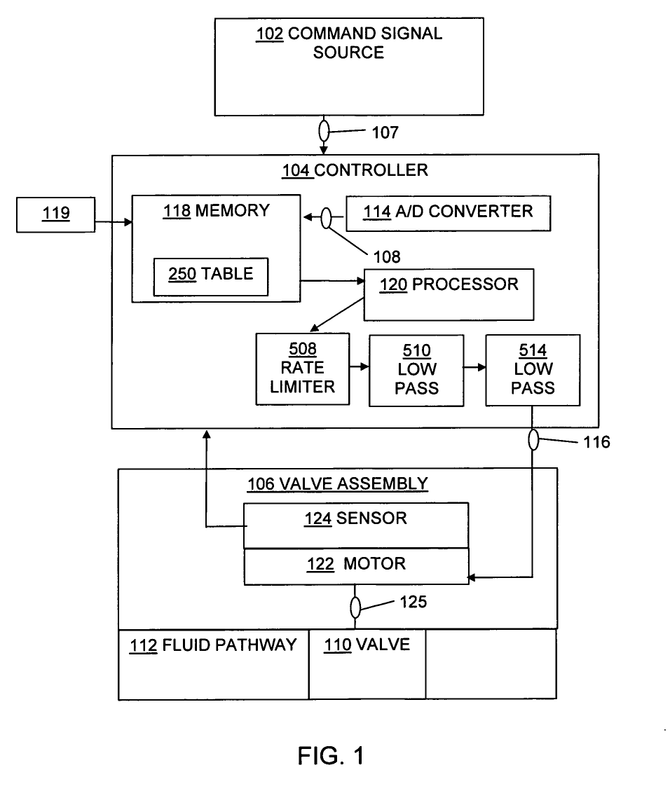

FIG. 1 illustrates a schematic representation of a valve assembly system 100. The valve assembly system 100 includes a command signal source 102, a controller 104, and a valve assembly 106.

The command signal source 102 is configured to provide a command signal 108 to the valve assembly 106 to control the positioning of a valve 110 of the valve assembly 106 to control a volume of fluid flowing through an associated conduit 112 (e.g., increase flow, decrease flow, terminate flow). For example, in one arrangement, the command signal source 102 is configured as a user-controlled device, such as a joystick. When actuated, the joystick provides the command signal 108 to the valve assembly 106 where the command signal 108 corresponds to a user-desired fluid flow rate through the conduit 112. While the command signal source 102 can provide the command signal 108 to the valve assembly 106 in a variety of formats, in one arrangement, the command signal source 102 generates an initial command signal having an initial command signal value of between about 0 V and 10 V, based upon user actuation. An analog-to-digital converter 114 intercepts the initial analog command signal 107 and converts the initial command signal from the analog to the digital domain and provides the resulting digital command signal 108 to the processor 120.

The controller 104 is disposed in electrical communication with the command signal source 102 and the valve assembly 106. The controller 104 is configured to intercept the command signal 107 from the command signal source 102 and provide a drive signal 116 to the valve assembly 106 based upon the command signal 107. As indicated above, while the command signal 107 can be utilized by the valve assembly 106 to adjust the positioning of the valve or valve element 110 within the fluid pathway 112, conventional valves 110 generally have non-linear rate-of-change characteristics which affects the volumetric flow rate through the fluid pathway 112. Accordingly, when the valve assembly positions the valve 110 to the commanded position, based upon the command signal 107, the actual flow rate through the fluid pathway 112 can be greater or less than the desired flow. To compensate for the non-linear rate-of-change characteristics of the valve 110, the drive signal 116 provided by the controller 104 adjusts the positioning of the valve 110 to a position greater than or less than the commanded position to provide a corrected or desired flow rate through the fluid pathway 112.

While the controller 104 can be configured in a variety of ways, in one arrangement, the controller includes a memory 118 and a processor 120. The memory 118 can be of any type of volatile or non-volatile memory or storage system such as a computer memory (e.g., random access memory (RAM), read only memory (ROM), or another type of memory), flash memory, or disk memory, such as hard disk, floppy disk, optical disk, for example. The memory 118 can be encoded with logic instructions and/or data 119 that allows the controller to adjust the positioning of the valve 110 to a position greater than or less than the commanded position. The processor 120 represents any type of circuitry or processing device such as a central processing unit, controller, application specific integrated circuit, Digital Signal Processor (DSP) or other circuitry that can access the memory 118 to allow the controller 104 run, execute, interpret, operate, or otherwise perform the logic instructions 119.

The valve assembly 106 includes a motor 122 disposed in electrical communication with the controller 104 and including an output shaft 125 coupled to the valve 110. The motor 122 is configured to receive the drive signal 116 from the controller 104 and rotate the output shaft 125 to move the valve 110 within the fluid pathway 112 to a position corresponding to the drive signal 116. For example, in one arrangement, the motor 122 is operable to position the valve between a 0% flow position and a 100% flow position in the fluid pathway 112. While the motor can be configured in a variety of ways, in one arrangement, the motor 122 is configured as a 3-phase, brushless DC motor having sensors 124, such as with three Hall sensors located 120° apart. In the case where the motor 122 is attached to a 60:1 reduction ratio gearbox, the Hall sensors 124 provide 1080 state counts for each gearbox output shaft revolution (i.e., 3 state counts per degree of rotation). While the valve assembly 106 can be configured in a variety of ways, in one arrangement the valve assembly 106 is configured as a poppet or butterfly valve. In another arrangement, the valve assembly 106 is configured as a servovalve assembly.

As indicated above, the controller 104 is configured to provide the drive signal 116 to the valve assembly 106 to adjust the positioning of the valve 110, relative to the fluid pathway 112, and a desired flow rate through the fluid pathway 112. In order to configure the controller 104 to provide an appropriate drive signal 116 in response to receiving a particular command signal 107, a manufacturer first obtains relationships between a particular valve assembly's actual flow rate, a commanded valve position, and a corrected, desired valve position to determine a flow rate characteristic of the valve assembly 106.

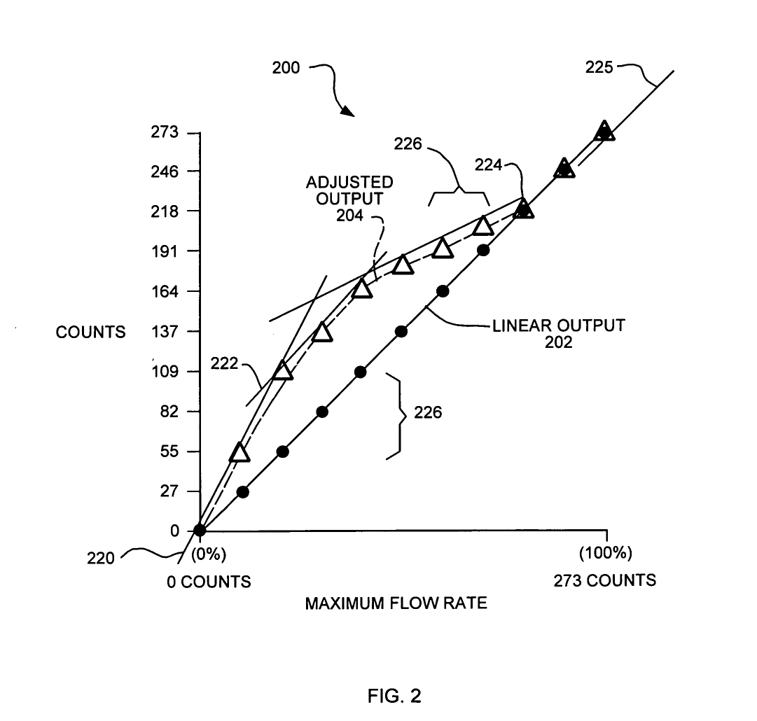

The manufacturer characterizes the valve assembly 106, in part, based upon the operating characteristics of the motor 122 and sensor 124. For example, assume the motor 122 is configured to provide between 0° minimum and 90° maximum rotation to the output shaft 125, which is operable to position the valve 110 between a closed (substantially 0% flow) stroke position and an open (substantially 100% or maximum flow) stroke position. Further assume that the sensor 124 is configured to output a minimum of 0 state counts (hereinafter “counts”) when the valve assembly 106 is disposed in the closed position and a maximum of 270 counts when the valve assembly 106 is disposed in the open position. The manufacturer divides the maximum number of counts among a set of flow rate values to generate a set of command count values. For example, assume the manufacturer establishes a table having a resolution of 1/3° or 1 count based upon 10% flow rate intervals (0%, 10%, 20%, . . . , 100%). As indicated in the graph 200 of FIG. 2, the manufacturer then distributes the command counts relative to the flow rate intervals, shown by curve 202.

The manufacturer further characterizes the valve assembly 106 based upon a relationship between the flow rate of fluid through an actual valve assembly 106 and an actual position of the valve 110 relative to the fluid pathway 112. For example, in order to further characterize the valve assembly 106, the manufacturer connects the valve assembly 106 to a fluid pathway 112 which carries a pressurized fluid. The manufacturer causes the motor 122 to rotate the output shaft 125 by a preset amount, such as in 5° increments. At each of the 5° increments, the manufacturer measures the flow rate through the valve assembly 106, the fluid temperature, the fluid pressure drop across the valve assembly 106, and drive count values generated by the sensor 124 where the drive count values are indicative of the actual stroke position of the valve 110 relative to the fluid pathway 112. Based upon these measurements, for a given flow rate through the valve assembly 106 (e.g., 10% of maximum, 20% of maximum, 30% of maximum, etc.) the manufacturer assigns the measured state counts to each of the flow rate intervals (0%, 10%, 20%, . . . , 100%) as indicated by an adjusted output curve 204 in FIG. 2.

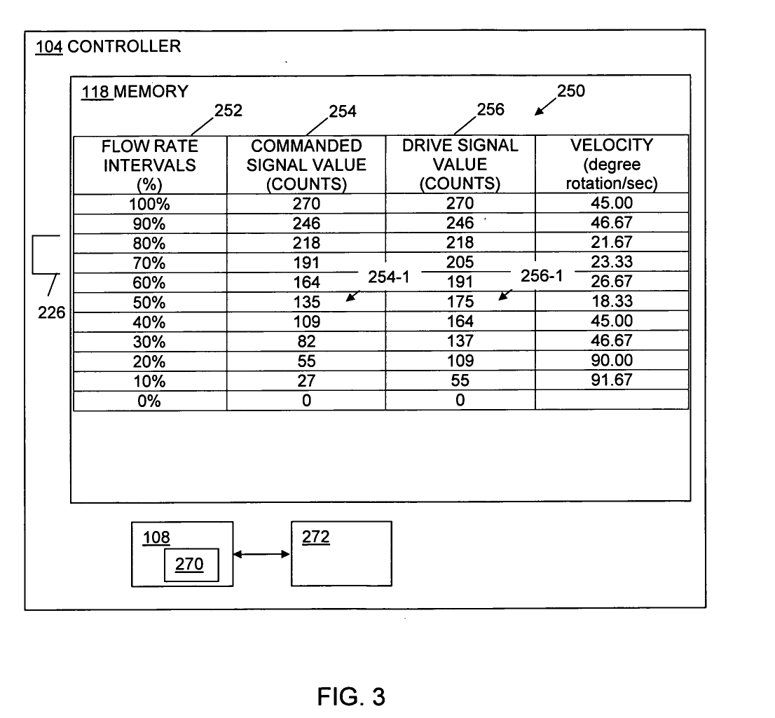

As indicated in FIG. 3, once the manufacturer has established the relationship between each of the flow rate intervals and the commanded counts and between each of the flow rate intervals and the drive counts for a particular valve assembly 106, the manufacturer configures the controller 102 with a flow control table 250. As indicated in FIG. 3, the flow control table 250 includes a set of flow rate intervals 252, a set of command signal values 254 and a set of drive signal values 256. The set of command signal values 254 correspond to the command count values described above and the set of drive signal values 256 correspond to the drive count values described above and as shown in FIG. 2. In the flow control table 250, each command signal value of the set of command signal values 254 corresponds to a desired valve stroke position of the valve 110 relative to the fluid pathway 112 to obtain a desired flow rate through the valve assembly and each drive signal value of the set of drive signal values 256 corresponds to an actual valve stroke position that obtains the desired flow rate through the valve assembly 106. In one arrangement, the manufacturer imports the flow control table 250 into the memory 118, such as a flash memory.

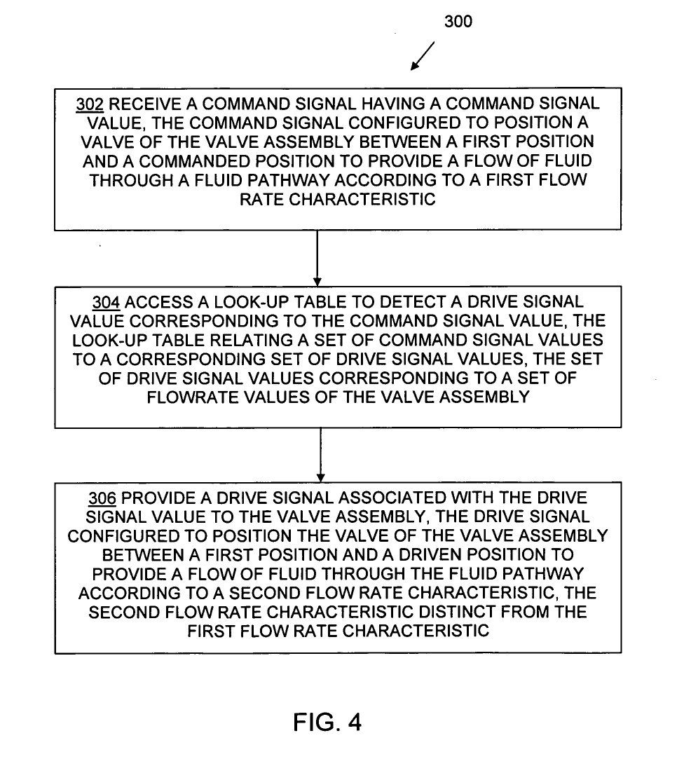

In the arrangement shown, the controller 104 utilizes the flow control table 250 to linearize the rate-of-change at which the flow through the valve assembly 106 changes as the motor 122 adjusts the position of the valve element 110 relative to the fluid pathway 112. FIG. 4 illustrates a flowchart 300 of a method performed by the controller 104 when utilizing the flow control table 250 to control the flow of fluid through the fluid pathway 112.

In step 302, the controller 104 receives a command signal 107 having a command signal value, the command signal 107 configured to position a valve 110 of the valve assembly 106 between a first position and a commanded position to provide a flow of fluid through a fluid pathway 112 according to a first flow rate characteristic. For example, with reference to FIG. 1, assume a user actuates the command signal source 102 to adjust the valve assembly 106 to produce a desired flow through the fluid path way 112 having a flow rate of 50% of the maximum flow rate. Further assume that as a result of the actuation, the command signal source 102 generates an initial command signal 107 having an initial command signal value of 5 V. In such a case, the A/D converter 114 intercepts the initial command signal 107 and converts the signal to a command signal 108 having an associated command signal count value of 135. However, with reference to FIG. 2, and with respect to operation of the motor 122, the command signal count value of 135 (i.e., half of the 270 sensor state counts from closed to fully open) can only cause the motor 122 to position the valve 110 relative to the fluid path way 112 to allow a flow rate of 30% of the maximum flow rate there through. Accordingly, command signals 108 provided by the command signal source 102 cause the motor to adjust the positioning of the valve 110 to allow a flow of fluid through the fluid pathway 112 according to a non-linear flow rate characteristic.

Returning to FIG. 4, in step 304, the controller 104 accesses a flow control table 250 to detect a drive signal value 256 corresponding to the command signal value 108, the flow control table 250 relating a set of command signal values 254 to a corresponding set of drive signal values 256, the set of drive signal values 256 and the set of command signal values 254 corresponding to a set of flow rate values 252 of the valve assembly 106. For example, with reference to FIGS. 1 and 2, when the controller 104 receives the analog command signal 107 from the command signal source 102, the controller 104 compares the digital command signal value 108, in this case 135 counts, with the set of command signal values 254 to detect a correspondence between the digital command signal value 108 and the set of command signal values 254. In the table 250, the controller 104 detects the presence of a command signal value 254-1 that corresponds to the digital command signal value 108 corresponding to the analog command signal 107 received from the command signal source 102. Based upon the correspondence, the controller 104 detects the corresponding drive signal value 256-1 operable to position the valve 110 at a position that allows for the desired flow rate of 50% of the maximum flow rate through the valve assembly 106.

Returning to FIG. 4, in step 306, the processor 104 provides a drive signal 116 associated with the drive signal value 256-1 to the valve assembly 106, the drive signal 116 configured to position the valve 110 of the valve assembly 106 between a first position and a driven position to provide a flow of fluid through fluid pathway 112 according to a second flow rate characteristic, the second flow rate characteristic distinct from the first flow rate characteristic. As indicated in FIG. 3, the drive signal value 256-1 of 175 counts corresponds to the desired corrected flow rate of 50% of the maximum flow rate through the fluid pathway 112. When the controller 104 transmits the corresponding drive signal 116 having the value of 175 to the motor 122, the motor 122 rotates the output shaft 125 until the sensors 124 generate a sensor signal having a value of 175 counts. Accordingly, the motor 122 moves the valve 110 via output shaft 125 according to the predetermined number of state counts (i.e., 175). The resulting, driven valve 110 position relative to the fluid pathway 112 can actually be more, or less, than 50% open to compensate for the non-linear flow characteristics of the valve assembly 106 and to provide a corrected flow rate. Such rotation of the output shaft 125 positions the valve 110 relative to the fluid pathway 112 to allow 50% of the maximum flow rate through the fluid pathway 112 and the valve assembly 106. It should be noted that the valve will follow the same curve determined by the drive signal values 256 in both the opening and closing directions.

With respect to the operation of the controller 104, the controller 104 is configured to control the positioning of the valve element 110 such that the valve element 110 is opened to a position either greater or less than the commanded position in order to provide the desired flow through the fluid pathway. Accordingly, in one embodiment the controller is configured to provide a linearization of flow characteristics through any liquid or gas media valve assembly. Additionally, because the operation of the valve assembly 106 is based upon the controller 104 providing the empirically generated values to the motor 122, the controller 104 does not require feedback from the valve element 110 to operate and position the valve element 110. Also, because the flow control table 250 is configured in software, a manufacturer can update the flow control table 250 to change one or both of the command signal values 245 and the drive signal values 256 to adjust the flow characteristics of the valve assembly 112.

While the controller 104 can utilize the flow control table 250 in order to linearize the flow of fluid through a fluid pathway 112, the controller 104, in one arrangement, is also configured to utilize the flow control table 250 to adjust the velocity of the valve 110. With reference to FIG. 2, as the valve 110 moves between a fully closed and a fully opened position, the slope of the curve 204 changes, indicating a change in velocity. For example, the adjusted output curve 204 of FIG. 2 illustrates a first portion 220 having a relatively steep slope, indicating a relatively large change in velocity, a second portion 222 having a relatively shallower slope indicating a deceleration of the valve 110, a third portion 224 having a shallower slope indicating further deceleration of the valve 110, and a fourth portion 225 having a relatively steep slope indicating acceleration of the valve 110. In order to provide a linear flow rate profile through the fluid pathway, the controller 104 is configured to adjust the velocity of the valve 110 as the valve 110 moves relative to the fluid pathway 112 between fluid rate intervals, represented as segments 226.

In one arrangement, the controller 104 is configured to adjust the velocity of the valve 110 between a first position and a driven position based upon a difference between two drive signal values of the set of drive signal values 256 and based upon a time differential between the first drive signal value and the second drive signal value. In one arrangement, the controller 104 is preconfigured with a time differential between segments 226. For example, assume the amount of time required to move the valve 110 from a substantially fully closed position to a substantially fully open position is based on 2.0 seconds stroke time (i.e., the motor 122 rotates the output shaft 125 between 0° and 90° to position the valve 110 between a substantially fully closed and a substantially fully open position). Based upon the flow control table 250 having a resolution of ten segments 226, the controller 104 is configured with a time differential of 0.2 sec/10% flow rate interval. Accordingly, with reference to the flow control table 250 of FIG. 3, if the number of drive signal counts for a particular segment 226 is relatively large, in response to receiving the drive signal 116 from the controller 104, the motor 122 moves the valve element 110 relatively faster and further in rotation. However, if the number of drive signal counts for a particular segment 226 is relatively small, the motor 122 moves the valve element 110 slower and less in rotation.

For example, with reference to the flow control table 250 of FIG. 3, the differential between the drive signal value at the 10% flow rate interval and the drive signal value at the 20% flow rate with reference is 54 state counts. With such a differential, the velocity of the valve 110 when the motor moves the valve between the 10% flow rate interval and the 20% flow rate interval is provided by the relationship: velocity=[(54 drive signal count differential)/(3 counts/1 degree rotation)]/[1/0.2 seconds]=90.00 degrees rotation/second. Accordingly, when positioning the valve 110 between the 10% flow rate interval and the 20% flow rate interval, the motor 122 rotates the output shaft 125 at 90.00 degree rotation/second, resulting in a relatively high velocity of the valve 110. By contrast, with reference to the flow control table 250, the differential between the drive signal value at the 40% flow rate interval and the drive signal value at the 50% flow rate interval is 11 state counts. Based upon the relationship: velocity=[(11 drive signal count differential)/(3 counts/1 degree rotation)]/[1/0.2 seconds]=18.33 degrees rotation/second. Accordingly, when positioning the valve 110 between the 40% flow rate interval and the 50% flow rate interval, the motor 122 rotates the output shaft 125 at 18.33 degrees rotation/second, resulting in a relatively low velocity of the valve 110. By allowing an adjustment of the velocity of the valve at each flow rate interval, the controller 104 linearizes the flow of fluid through the fluid pathway 112 during operation.

In one arrangement, the controller 104 is configured with a velocity limit safeguard. For example, assume the case where the controller 104 receives from the command signal source 102 a command signal 118 indicating an abrupt change in valve velocity 110 from relatively very low to relatively very high. In such a case, the controller 104 detects a current level 270 of the command signal 118 and compares the current level 270 with a threshold current value limit 272. In the case where the current level 270 exceeds the threshold current value limit 272, the controller 104 adjusts the command signal 118 to limit the rate of change of movement of the valve element 110. Such adjustment minimizes damage to the valve assembly 106 as caused by rapid acceleration or deceleration of the motor 122 and valve 110.

As indicated above, the controller 104 is configured to control the velocity of a valve element 110 to providing a providing a linearized flow volume rate-of-change through a fluid pathway 112. In certain cases, if the valve element 110 were to provide a linear flow profile between a substantially fully closed and a substantially fully open position, the pressure change within the fluid path way 112 could damage certain components. For example, as indicated above, in a poppet valve, if a valve element 110 is allowed to rapidly change position relative to a valve seat when it is close to the seat, a pressure surge can occur either downstream, when opening, or upstream, when closing, from the valve element 110. This pressure surge can cause damage to the valve 110 or other system components. To minimize this pressure surge, the controller 104 moves the valve 110 at a relatively low velocity when the valve element 110 approaches or leaves the valve seat and moves the valve 110 relative at a relatively high velocity for the remainder of the valve stroke.

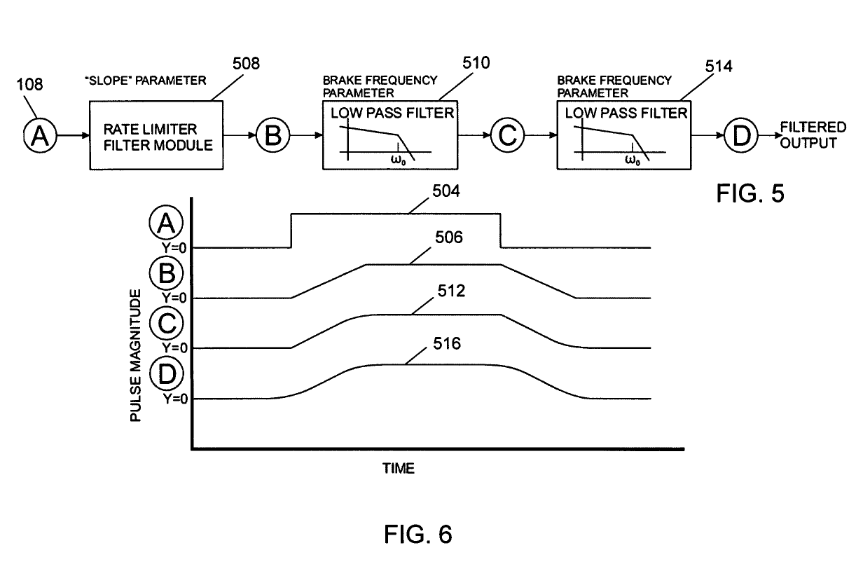

In order to change the rate-of-change of position between a poppet valve element and seat the controller 104 is configured to modify at least one of a leading velocity differential and a trailing velocity differential of a command signal 108 in order to damp or reduce the velocity of the valve 110 between a first position and a driven position. For example and with reference to FIGS. 5 and 6, in use, the processor receives a digital command signal 108 having a relatively square pulse magnitude 504. In order to adjust the velocity rate of the digital command signal 108, as shown by curve 506 the controller 104 utilizes a rate limiter filter module 508. The corrected command signal is then sent to a low pass filter to further shape the digital command signal 108. For example, in one arrangement, the digital command signal 108, after passing through the rate limiter filter module 508, is sent to a first low pass filter 510 to modify the velocity profile of the signal to round the trailing edges, as shown in curve 512. The modified signal is then sent to a second low pass filter 514 to modify the velocity profile of the signal to round the leading edges, as shown in curve 516. The controller 104 sends the modified command signal to the valve assembly 106 in order to move the valve 110 at a relatively low velocity as the valve element 110 approaches or leaves the valve seat. By shaping the flow profile, the controller 104 reduces the effect of water hammer and system pressure surges on the valve assembly in both the opening and closing directions.

While various embodiments of the invention have been particularly shown and described, it will be understood by those skilled in the art that various changes in form and details may be made therein without departing from the spirit and scope of the invention as defined by the appended claims.

For example, with respect to the example flow control table 250 shown in FIG. 3 and the curve 204 illustrated in FIG. 2, the table 250 and curve 204 include only ten flow rate intervals or segments 226. Such illustration is by way of example only. In one arrangement, the table 250 and curve 204 can include a greater number of segments 226 for an increased resolution to provide finer control of the rotational stroke characteristics of the valve. Alternately, the table 250 and curve 204 can include a reduced number of segments 226.

Additionally, with respect to the example flow control table 250, only a single flow control table 250 shown and described. For example, as indicated above, based upon the configuration of the flow control table 250, the valve assembly system 106 provides a substantially linear flow output response based upon the input command signal. Such indication is by way of example only. In one arrangement, the controller 104 is configured with multiple flow control tables, each flow control table configured to provide a specific flow output through the fluid pathway 112. For example, while the controller 104 can be configured with a flow control table 250 that provides a linear flow output response based upon an input command signal 107, the controller 104 can also be configured with flow control tables that provide a saw tooth flow output response and a square wave output response, for example, as well.

As indicated above with respect to FIG. 4, the controller 104 receives a command signal 107, the controller 104 accesses a flow control table 250 to detect a drive signal value 256 corresponding to the command signal value 107. In certain cases the command signal value of the command signal 107 will not exactly match a drive signal value 256 in the flow control table 250. In case where the controller 104 detects a lack of correspondence between the received command signal value and the set of command signal values carried by the flow control table 250, the controller 104 is configured to interpolate between two command signal values to detect an appropriate drive signal value.

What is claimed is:

1. A method for controlling a flow rate characteristic of a valve assembly, comprising:
receiving a command signal having a command signal value, the command signal configured to position a valve of the valve assembly between a first position and a commanded position to provide a flow of fluid through a fluid pathway according to a first flow rate characteristic;
accessing a flow control table to detect a drive signal value corresponding to the command signal value, the flow control table relating a set of command signal values to a corresponding set of drive signal values, the set of drive signal values and the set of command signal values corresponding to a set of flow rate values of the valve assembly; and
providing a drive signal associated with the drive signal value to the valve assembly, the drive signal configured to position the valve of the valve assembly between a first position and a driven position to provide a flow of fluid through the fluid pathway according to a second flow rate characteristic, the second flow rate characteristic distinct from the first flow rate characteristic.

2. The method of claim 1, comprising establishing the flow control table with the set of command signal values and the set of drive signal values, each command signal value of the set of command signal values corresponding to a desired valve stroke position of the valve to obtain a desired flow rate through the fluid pathway and each drive signal value of the set of drive signal values corresponding to an actual valve stroke position to obtain the desired flow rate through the fluid pathway.

3. The method of claim 1, comprising adjusting a velocity of the valve between the first position and the driven position based upon a difference between two drive signal values of the set of drive signal values and based upon a time differential between the first drive signal value and the second drive signal value.

4. The method of claim 3, comprising:
detecting the command signal as having a current value above a threshold current value limit; and
limiting the velocity of the valve between the first position and the driven position in response to the command signal having the current value above a threshold current value limit.

5. The method of claim 3, comprising damping the velocity of the valve between the first position and the driven position.

6. The method of claim 5, wherein damping the velocity of the valve between the first position and the driven position comprises:
modifying at least one of a leading velocity differential and a trailing velocity differential of the command signal to generate a modified command signal; and
providing the modified command signal to the valve assembly to damp the velocity of the valve.

7. The method of claim 1, wherein accessing a flow control table to detect a drive signal value corresponding to the command signal value comprises:
detecting a lack of correspondence between the received command signal value and the set of command signal values carried by the flow control table; and
interpolating the drive signal value corresponding to the command signal value based upon the command signal values carried by the flow control table.

8. The method of claim 1, wherein:
receiving the command signal having the command signal value comprises, receiving the command signal having the command signal value the command signal configured to position a valve of the valve assembly between a first position and a commanded position to provide a flow of fluid through the fluid pathway according to a nonlinear flow rate characteristic; and
providing the drive signal associated with the drive signal value to the valve assembly comprises providing the drive signal associated with the drive signal value to the valve assembly, the drive signal configured to position the valve of the valve assembly between a first position and a driven position to provide a flow of fluid through the fluid pathway according to a linear flow rate characteristic.

9. A valve assembly system, comprising:
a valve assembly having a valve disposed within a fluid pathway and a motor operatively coupled to the valve; and
a controller in electrical communication with the motor, the controller configured to:
receive a command signal having a command signal value, the command signal configured to cause the motor to position the valve of the valve assembly between a first position and a commanded position to provide a flow of fluid through the fluid pathway according to a first flow rate characteristic;
access a flow control table to detect a drive signal value corresponding to the command signal value, the flow control table relating a set of command signal values to a corresponding set of drive signal values, the set of drive signal values and the set of command signal values corresponding to a set of flow rate values of the valve assembly; and
provide a drive signal associated with the drive signal value to the valve assembly, the drive signal configured to cause the motor to position the valve of the valve assembly between a first position and a driven position to provide a flow of fluid through the fluid pathway according to a second flow rate characteristic, the second flow rate characteristic distinct from the first flow rate characteristic.

10. The valve assembly system of claim 9, wherein the controller is configured to receive the flow control table with the set of command signal values and the set of drive signal values, each command signal value of the set of command signal values corresponding to a desired valve stroke position of the valve to obtain a desired flow rate through the fluid pathway and each drive signal value of the set of drive signal values corresponding to an actual valve stroke position to obtain the desired flow rate through the fluid pathway.

11. The valve assembly system of claim 10, wherein the controller is configured to adjust a velocity of the valve between the first position and the driven position based upon a difference between two drive signal values of the set of drive signal values and based upon a time differential between the first drive signal value and the second drive signal value.

12. The valve assembly system of claim 11, wherein the controller is configured to:
detect the command signal as having a current value above a threshold current value limit; and
cause the motor to damp the velocity of the valve between the first position and the driven position in response to the command signal having the current value above a threshold current value limit.

13. The valve assembly system of claim 11, wherein the controller is configured to damp the velocity of the valve between the first position and the driven position.

14. The valve assembly system of claim 13 wherein, when damping the velocity of the valve between the first position and the driven position, the controller is configured to:
modify at least one of a leading velocity differential and a trailing velocity differential of the command signal to generate a modified drive signal value; and
provide the modified command signal to the valve assembly to damp the velocity of the valve.

15. The valve assembly system of claim 9, wherein when accessing a flow control table to detect a drive signal value corresponding to the command signal value, the controller is configured to:
detect a lack of correspondence between the received command signal value and the set of command signal values carried by the flow control table; and
interpolate the drive signal value corresponding to the command signal value based upon the command signal values carried by the flow control table.

16. The valve assembly system of claim 9, wherein:
when receiving the command signal having the command signal value, the controller is configured to receive the command signal having the command signal value the command signal configured to position a valve of the valve assembly between a first position and a commanded position to provide a flow of fluid through the fluid pathway according to a nonlinear flow rate characteristic; and
when providing the drive signal associated with the drive signal value to the valve assembly the controller is configured to provide the drive signal associated with the drive signal value to the valve assembly, the drive signal configured to position the valve of the valve assembly between a first position and a driven position to provide a flow of fluid through the fluid pathway according to a linear flow rate characteristic.

17. A computer program product having a computer-readable medium including computer program logic encoded thereon that, when performed on a controller of a computerized device configures the controller to:
receive a command signal having a command signal value, the command signal configured to cause the motor to position the valve of the valve assembly between a first position and a commanded position to provide a flow of fluid through a fluid pathway according to a first flow rate characteristic;
access a flow control table to detect a drive signal value corresponding to the command signal value, the flow control table relating a set of command signal values to a corresponding set of drive signal values, the set of drive signal values and the set of command signal values corresponding to a set of flow rate values of the valve assembly; and
provide a drive signal associated with the drive signal value to the valve assembly, the drive signal configured to cause the motor to position the valve of the valve assembly between a first position and a driven position to provide a flow of fluid through the fluid pathway according to a second flow rate characteristic, the second flow rate characteristic distinct from the first flow rate characteristic.

18. The computer program product of claim 17 having a computer-readable medium including computer program logic encoded thereon that, when performed on a controller of a computerized device configures the controller to adjust a velocity of the valve between the first position and the driven position based upon a difference between two drive signal values of the set of drive signal values and based upon a time differential between the first drive signal value and the second drive signal value.

19. The computer program product of claim 17 having a computer-readable medium including computer program logic encoded thereon that, when performed on the controller of the computerized device configures the controller to damp the velocity of the valve between the first position and the driven position.
